(19) United States
(12) Patent Application Publication
(10) Pub. No.: US 2025/0007423 A1
(43) Pub. Date: Jan. 2, 2025

(54) Power converter, electrical machine unit and method for current conversion

(71) Applicant: SEG Automotive Germany GmbH, Stuttgart (DE)

(72) Inventor: Nima SAADAT, Stuttgart (DE)

(21) Appl. No.: 18/751,581

(22) Filed: Jun. 24, 2024

(30) Foreign Application Priority Data
Jun. 27, 2023 (DE) 102023116938.6

(51) Int. Cl. H02M 7/5387; H02M 1/08; H02M 7/483

(52) U.S. Cl. CPC H02M 7/53871; H02M 1/081; H02M 7/483

(57) ABSTRACT

A power converter has two DC voltage terminals and a plurality of AC voltage terminals. The power converter includes a first partial power converter and a second partial power converter, wherein the first partial power converter comprises first semiconductor switching elements and is configured as a three-level power converter or power converter with more than three levels, wherein the second partial power converter comprises second semiconductor switching elements and is configured as a two-level power converter, and wherein the first partial power converter and the second partial power converter are each connected or are connectable between the two DC voltage terminals and the plurality of AC voltage terminals.

### CROSS-REFERENCE TO RELATED APPLICATIONS

This application claims priority to German Patent Application No. 102023116938.6 filed Jun. 27, 2023, the entirety of which is incorporated by reference.

### TECHNICAL FIELD

The present invention relates to a power converter, e.g. for an electrical machine, an electrical machine unit comprising an electrical machine and a power converter, and to a method for current conversion using such a power converter.

### BACKGROUND

In electrical machines, particularly those used as motors and/or generators, and especially when used in vehicles, inverters (power converters) are used to rectify the alternating current generated or to alternate the direct current applied. However, power converters can also be used in many other areas, e.g. electrical appliances.

### SUMMARY

According to the invention, a power converter, an electrical machine unit and a method for current conversion with the features of the independent patent claims are proposed. Advantageous embodiments are the subject of the dependent claims and the following description.

The invention relates to power converters or inverters in general and, in particular, power converters or inverters for electrical machines and their operation. In the context of the invention, the combination of electrical machine and associated power converter should also be referred to as an electrical machine unit. Typically, the power converter is attached or mounted to the electrical machine. The electrical machine unit can be part of a vehicle, in particular also be used as a traction drive. Possible electrical machines include, for example, synchronous machines, synchronous reluctance machines, induction machines, permanent magnet machines and others.

Typical electrical machines have, for example, three phases or a multiple thereof; although the explanation of the present invention is given primarily in relation to electrical machines with three phases, this also applies to a different number of phases, e.g. six, nine, twelve or 15 phases. In principle, however, the electrical machine can also have only one or two phases.

In addition, the electric machine has a rotor that can be permanently and/or externally excited. A preferred use is also in so-called high-voltage applications, in which the electrical machine is operated with a voltage of 48 V, 60 V or higher, for example.

As mentioned, however, power converters can also be used in other areas, e.g. in electrical devices or in the operation of electrical devices, if, for example, direct current is to be converted into alternating current (e.g. single-phase or three-phase) or vice versa.

The power converter has two DC voltage connections and several AC voltage connections. When used with or for an electrical machine with, for example, three phases, each of the three phases can be connected to one of three AC voltage connections. If there is only one phase, this can be connected to two AC voltage connections, for example. When used in a vehicle, the DC voltage connections can be connected to an energy storage device such as a battery, for example.

A power converter typically comprises several half bridges, each with two semiconductor switching elements, usually a high-side switching element and a low-side switching element. With a center tap, i.e. between the two semiconductor switching elements, the multiple half bridges are usually connected to one of the multiple AC voltage connections. The DC voltage sides of the multiple half-bridges, on the other hand, are generally connected to each other and thus to one of the DC voltage connections. In addition, an DC link capacitor can be connected between the DC voltage connections. In particular, this can be a so-called two-level converter if there are two different voltage levels on the DC voltage side, each of which is then connected directly to one of the two DC voltage connections and therefore corresponds to their voltage level.

There are also so-called three-level converters, in which a third voltage level is provided on the DC voltage side, which is typically located halfway between the voltage levels of the two DC voltage connections. The operating noise of the three-level converter is lower than that of the two-level converter. Particularly with high currents and/or input voltages, the change in current and voltage over time is less than with the two-level converter. The two-level converter requires fewer components.

As has been shown, it is particularly efficient and advantageous to combine a three-level converter and a two-level converter. The three-level converter can be regarded as the first partial power converter and the two-level converter as the second partial power converter, both of which are part of the actual power converter.

The two partial power converters can be connected in parallel to each other and, in particular, be designed separately from each other, e.g. with separate control units. This allows a more flexible design of the power converter. The partial power converters can, for example, be arranged in different housings, even at different locations or on different sides of the electrical machine if required. The two partial power converters can also be integrated into each other, in which case they are also connected in parallel. This allows a more compact design of the power converter, although attention may have to be paid to any parasitic inductances.

In addition, one or more DC link capacitors (depending on the type of three-level converter) can be connected between the two DC voltage connections, which are then available for both partial power converters. In this context, the power converter can also be referred to as a hybrid power converter.

Instead of the three-level power converter, however, a power converter with more than three levels, e.g. a four- or five-level power converter, can also be used as the first partial power converter. In this case, there are correspondingly more voltage levels.

The semiconductor switching elements of a power converter can in turn comprise, for example, several parallel chips in a power housing or several parallel discrete semiconductor switches in order to achieve a desired maximum current. Typically used types of semiconductor switching elements are e.g. IGBTs or MOSFETs, e.g. SiC-MOSFETs or GaN-HEMTs (Gallium-Nitride-Transistors). The SiC MOSFET is more efficient, for example, due to the lower RDSon resistance at partial loads and the lower switching losses. On the other hand, the resistance of IGBTs at currents above a threshold value is lower than that of SiC components, which is why IGBTs are particularly advantageous compared to SiC components at high current loads. In addition, IGBTs are usually significantly cheaper than SiC MOSFETs. The IGBT is also a more robust component compared to SiC components.

In general, different types of semiconductor switching elements have different advantages and disadvantages.

As has been found, it is particularly efficient and advantageous to use two partial power converters, each with several semiconductor switching elements, in a power converter, wherein the semiconductor switching elements of the two partial power converters are in particular different, i.e. in particular of different type or different kind, preferably IGBTs (possibly GaN-based) in one of the partial power converters and MOSFETs, e.g. SiC-MOSFETs and/or GaN-HEMTs in the other of the partial power converters.

The first partial power converter can have several, e.g. three, first half-bridges, each with two first semiconductor switching elements, e.g. IGBTs. As already mentioned, the two first semiconductor switching elements can also be high-side and low-side semiconductor switching elements. In addition, the first partial power converter can have one or more further first semiconductor switching elements per first half-bridge in order to be able to generate the third voltage level.

A distinction can be made between different types of three-level converters. For example, the first partial power converter can be designed as a three-level converter of the so-called T-type, NPC-type or flying capacitor type. However, other types of three-level power converters are also possible, e.g. active NPC type, cascaded H-bridge multilevel power converter or others. A more detailed explanation and description of these types of three-level power converters, in particular with regard to the circuitry and the necessary first semiconductor switching elements, is provided in the description of the drawings.

The second partial power converter can also have several, e.g. also three, half-bridges, each with two second semiconductor switching elements, e.g. MOSFETs. As already mentioned, the second semiconductor switching elements can also be high-side and low-side semiconductor switching elements. The first semiconductor switching elements and the second semiconductor switching elements are different from each other, in particular they are of different types.

This means that two different technologies can be used in relation to the semiconductor switching elements, so that the performance of the power converter at partial loads, for example, is similar to that of a pure SiC-MOSFET power converter. The use of IGBTs means, for example, that the SiC-SiC MOSFETs do not have to be the same size as the peak power and the costs of the power converter are thus significantly reduced.

The use of IGBT modules/switches significantly increases the robustness of the power converter. By using two half bridges per phase, the switching pattern of the power converter can have a greater degree of freedom and the size of the DC link capacitor can be reduced.

Two-level power converters are typically available, for example, in the 1200 V class and three-level power converters, in particular with IGBTs or even GaN-based, are typically available, for example, in the 650 V class. The hybrid power converter can then be used to operate an 800 V electric drive, for example, although the present invention is not limited to 800 V.

The proposed power converter also allows different operating modes. In a partial operating mode, for example, only one of the two partial power converters can be used as a power converter, while the other is inactive.

In a first partial operating mode, e.g. with partial or light loads up to medium loads—or generally with a requested load below a predetermined threshold value—only the second partial converter is used to direct the current, for example, while the first partial converter is inactive. A control or regulating unit, e.g. for an electrical machine, therefore controls the electrical machine, for example, only with the second partial power converter, which has the MOSFETs, for example.

In a second partial operating mode, e.g. with a high load or high torque, but at least with a higher load and/or higher torque than in the first partial operating mode—or generally with a requested load below a predetermined threshold value—the first partial power converter is used, for example, to convert the current and is operated, e.g. in PWM switching, while the second partial power converter is inactive. An open-loop or closed-loop control unit therefore controls the electrical machine, for example, only with the first partial power converter, which has the IGBTs, for example.

Furthermore, a mixed operating mode can be provided in which the first and second partial power converters are active and used together.

Here, for example, in a first mixed operating mode (which can also be referred to as boost mode), the first partial converter (the three-level converter, in particular with IGBTs) can be switched on or activated first. Then the second partial converter (the two-level converter, especially with MOSFETs) is switched on or activated; this allows the current to be increased (as the rated power of the second partial converter is usually lower). The voltage of the gate and the impedance of the line should be set so that the current is correctly divided between the two partial power converters and overloading is avoided.

If the rated power of the two partial converters is almost the same (i.e. within certain tolerances), then a second mixed operating mode can be used. In this case, the bridge with the lower switching losses can be switched on or activated first and then the other bridge can be switched on or activated; typically, the switching losses in the second partial power converter will be lower than in the first partial power converter, the three-level power converter with IGBTs, for example. The current sharing between the bridges (or partial power converters) considerably reduces the conduction loss without significantly increasing the switching losses. When switching off, the bridge or partial power converter with the higher switching losses can be switched off and then the bridge or partial power converter with the lower switching losses is switched on.

Furthermore, for example, a charging or energy transfer mode, in particular an integrated charging mode, can be provided. Here it is preferable if the charging of a battery (or generally an energy transfer between an energy storage system and a power grid) is carried out via the second partial power converter (i.e. in particular with the MOSFETs); here the combination of the machine winding with the second partial power converter can then form an AC rectifier or, in the case of a charging adaptation, they can work like a DC-DC converter, e.g. to convert a 400V to 800V DC charging system). In this case, the second partial power converter is suitable due to its better energy efficiency.

An active short-circuit mode can also be provided, for example. In this mode, all low-side or high-side switches can be closed. For this purpose, the low-side switches of the first partial power converter (with e.g. IGBTs) are closed first (all switches between the center tap and the negative DC voltage connection, B−, these are typically two series switches for Fly Cap and NPC and only one switch for the T-type) and then the low-side switches of the second partial power converter (with the MOSFETs). To open, first the second and then the first partial converter can be switched off. The same procedure can be used for the high-side switches in the event of an active short circuit. This mode is useful when the machine current is very high during the first few cycles of the active short circuit and the switches do not need to be oversized based on this current. Again, special care should be taken when splitting the current between IGBT and SiC switches.

Further advantages and embodiments of the invention are shown in the description and the accompanying drawing.

The invention is illustrated schematically in the drawing by means of embodiment examples and is described below with reference to the drawing.

### BRIEF DESCRIPTION OF THE DRAWINGS

FIG. 1a schematically shows a power converter according to an embodiment.

FIG. 1b schematically shows a power converter according to an embodiment.

FIGS. 2a, 2b show diagrams illustrating principles of a power converter, in embodiments.

FIG. 3a schematically shows a power converter according to an embodiment.

FIG. 3b schematically shows a power converter according to an embodiment.

FIG. 4a schematically shows a power converter according to an embodiment.

FIG. 4b schematically shows a power converter according to an embodiment.

FIG. 5 schematically shows methods according to embodiments.

### DETAILED DESCRIPTION

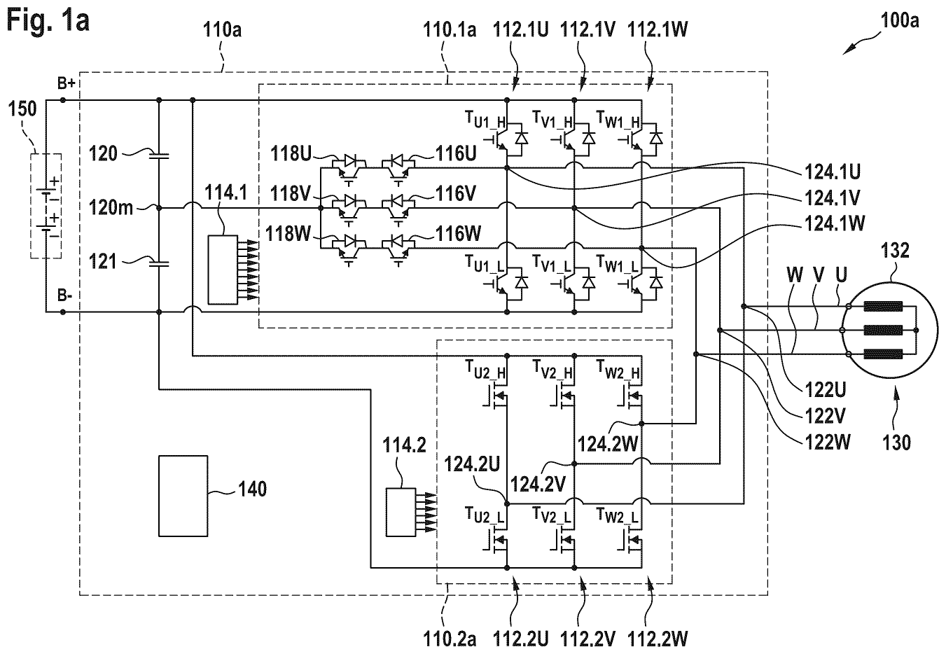

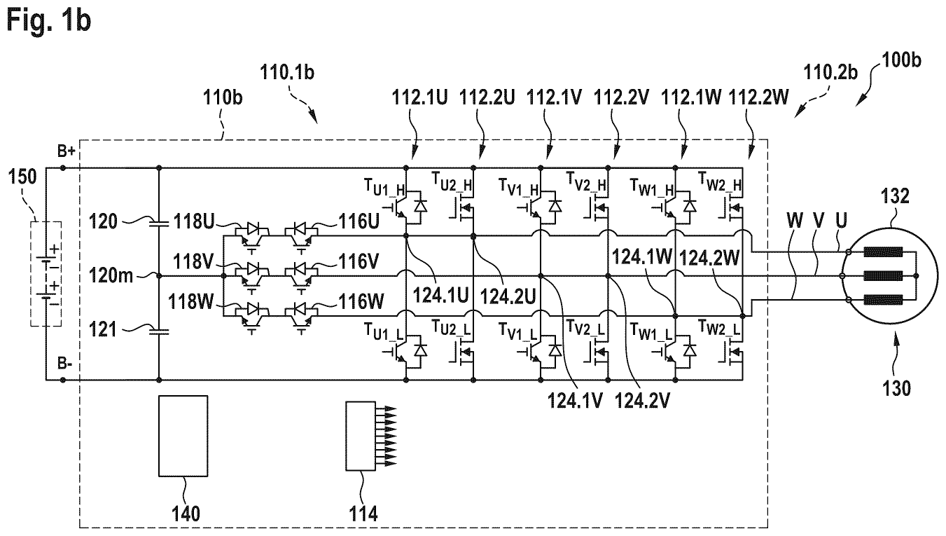

FIG. 1a schematically shows an electrical machine unit 100a, which has a power converter 110a and an electrical machine 130. In addition, an energy storage unit 150 configured as a battery and a computing unit 140 configured as an MCU are shown by way of example, whereby the computing unit 140 can be part of the electrical machine unit 100a and can be configured to operate it.

The electrical machine 130 is connected to the power converter or inverter 110a. The power converter 110a is in turn connected to the energy storage device 150 via two series-connected DC link capacitors 120, 121. Instead of two series-connected DC link capacitors, a single (possibly larger) DC link capacitor could also be used. The DC voltage provided by the battery 150 can be converted into AC voltage for the motorized operation of the electric machine 130 via the power converter 110a. Conversely, AC voltage generated during generator operation of the electric machine 130 can also be converted into DC voltage via the (thus bidirectional) power converter 110a in order to charge the battery 150.

In particular, the power converter 110a may be a power converter according to the invention in a preferred embodiment. As already mentioned, the power converter can be provided not only for the operation of an electrical machine, but also for other electrical devices, for example if direct voltage is to be converted into alternating voltage or vice versa. In the following, however, the invention will be explained by way of example using it for the operation of an electrical machine, for example in a vehicle which, in addition to the electrical machine, also comprises the battery.

Three phases U, V and W are shown for the electrical machine 130, each comprising a phase winding 132 (designated only once). It should be noted that the terms phase and phase winding can also be used synonymously, whereby phase winding usually (only) refers to the winding or coil within the stator. The phase windings 132 are part of a stator of the electrical machine; a rotor of the electrical machine is not shown here.

The power converter 110a comprises two partial power converters, a first partial power converter 110.1a and a second partial power converter 110.2a. In addition, the power converter 110a comprises two DC voltage connections B+, B− and several, for example three, AC voltage connections 122U, 122V, 122W. The power converter 110a can be (electrically) connected or, as shown here, is connected to the energy storage device 150 via the DC voltage connections B+, B−. The DC link capacitors 120, 121 are also connected between the DC voltage connections. Via the AC voltage connections 122U, 122V, 122W, the power converter 110a can be connected to the phases of the electrical machine (electrically) or, as shown here, is connected.

The first partial power converter 110.1a has, for example, three first half-bridges 112.1U, 112.1V, 112.1W. The number of half-bridges corresponds in particular to the number of AC voltage connections. Each of the three first half-bridges in turn has two first semiconductor switching elements, a high-side switching element T_{U1_H}, T_{V1_H} or T_{W1_H}, and a low-side switching element T_{U1_L}, T_{V1_L} or T_{W1_L}. Each of the first half-bridges has a center tap 124.1U, 124.1V, 124.1W, which is arranged between the two first semiconductor switching elements and via which the respective half-bridge is electrically connected or can be connected to the respective phase connection.

The DC voltage sides of the first half bridges are each (electrically) connected to each other and to one of the two DC voltage connections. The DC voltage side located on the side of the high-side switching elements is connected to the positive DC voltage connection B+, and the DC voltage side located on the side of the low-side switching elements is connected to the negative DC voltage connection B−.

Furthermore, the first partial power converter 110.1a comprises, by way of example, a plurality of further first semiconductor switching elements 116U, 118U, 116V, 118V, 116W, 118W (center switching elements), two of which are each connected between a center tap 124.1U, 124.1V, 124.1W on the AC voltage side corresponding to their designation and jointly to a center tap 120m between the two intermediate circuit capacitors 120, 121. The first semiconductor switching elements 116U, 118U are connected in series and in opposite directions; in this way, a bidirectional switch is formed. These middle switching elements and the high-side and low-side switching elements thus form a T-shape. These switching elements can be combined in a package for each half bridge. The same applies to the first semiconductor switching elements 116V, 118V and 116W, 118W.

These additional first semiconductor switching elements 116U, 118U, 116V, 118V, 116W, 118W can be used to generate a further average voltage level in addition to the voltage levels of the DC voltage connections. This results in a three-level power converter of the T-type.

Furthermore, the first partial power converter 110.1a comprises a control unit 114.1 configured as a gate driver, via which the first semiconductor switching elements can be controlled, i.e. opened and closed or be switched to non-conductive and conductive. It should be mentioned that distributed gate drivers can also be used.

The second partial power converter 110.2 comprises, by way of example, three second half bridges 112.2U, 112.2V, 112.2W. The number of half-bridges corresponds in particular to the number of AC voltage connections. Each of the three second half-bridges in turn has two second semiconductor switching elements, a high-side switching element T_{U2_H}, T_{V2_H} or T_{W2_H}, and a low-side switching element T_{U2_L}, T_{V2_L} or T_{W2_L}. Each of the second half-bridges has a center tap 124.2U, 124.2V, 124.2W, which is arranged between the two second semiconductor switching elements and via which the respective half-bridge is electrically connected or can be connected to the respective phase connection.

The DC voltage sides of the second half bridges are each (electrically) connected to each other and to one of the two DC voltage connections. The DC voltage side located on the side of the high-side switching elements is connected to the positive DC voltage connection B+, and the DC voltage side located on the side of the low-side switching elements is connected to the negative DC voltage connection B−.

The second partial power converter is therefore a two-level power converter.

Furthermore, the second partial power converter 110.2a has a control unit 114.2 configured as a gate driver, via which the second semiconductor switching elements can be controlled, i.e. opened and closed or be switched to non-conductive and conductive.

The first partial power converter 110.1a and the second partial power converter 110.2a are thus each constructed like a conventional three-level converter or two-level converter, whereby both are connected in parallel to one another and each between the two DC voltage connections B+, B− and the multiple AC voltage connections 122U, 122V, 122W. In addition, the first partial power converter 110.1a and the second partial power converter 110.2a are designed separately from one another.

The MCU 140 can, for example, be configured to control the first partial power converter 110.1a and the second partial power converter 110.2a via their respective gate drivers 114.1, 114.2, for example via suitable PWM signals.

There is a further difference between the first partial power converter 110.1a and the second partial power converter 110.2a. The first semiconductor switching elements T_{U1_H}, T_{V1_H}, T_{W1_H}, T_{U1_L}, T_{V1_L}, T_{W1_L} and 118U, 118U 116V, 118V, 116W, 118W are different from the second semiconductor switching elements T_{U2_H}, T_{V2_H}, T_{W2_H}, T_{U2_L}, T_{V2_L}, T_{W2_L}, in particular with regard to their kind or type.

Preferably, the first semiconductor switching elements are designed as IGBTs (IGBT stands for “insulated-gate bipolar transistor”), while the second semiconductor switching elements are designed as MOSFETs (MOSFET stands for “metal-oxide-semiconductor field-effect transistor”), in particular as SiC MOSFETs. SiC stands for silicon carbide, and such SiC MOSFETs are MOSFETs with a wide bandgap.

In this way, the first partial power converter 110.1a and the second partial power converter 110.2a are differently suited for different conditions; depending on the situation, only one of the partial power converters or both can be used together. Irrespective of this, the use of the two partial power converters connected in parallel allows inherent fault safety.

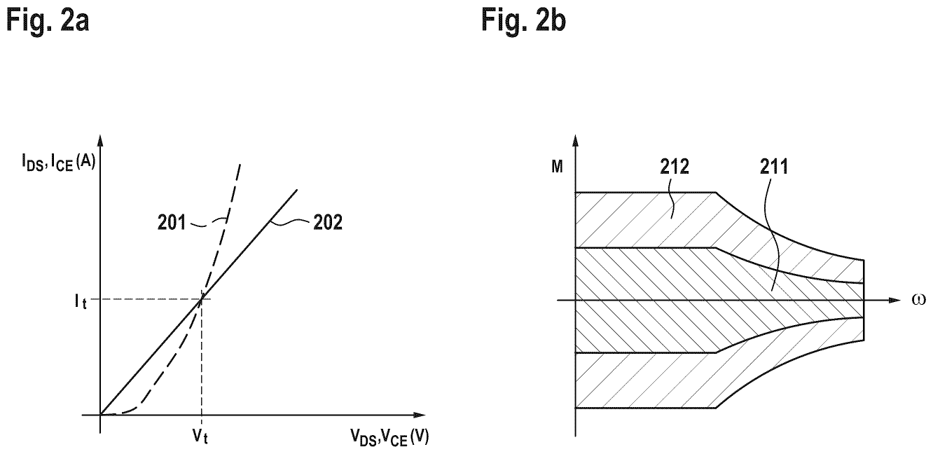

FIG. 2a shows a diagram in which typical current-voltage characteristics for an IGBT (curve 201) and a SiC MOSFET (curve 202) are shown. A current I_{DS} or I_{CE} in A is plotted against a voltage V_{DS} or V_{CE} in V. In the indices, DS stands for drain-source and applies to the SiC MOSFET. CE stands for collector-emitter and applies to the IGBT. Vₜ and Iₜ denote a threshold voltage and a threshold current respectively.

SiC MOSFETs are more efficient due to the lower RDSon resistance at partial loads and the lower switching losses. As can be seen in FIG. 2a, the resistance of IGBTs at currents above Iₜ is lower than that of SiC components, which is why IGBTs are particularly advantageous compared to SiC components at high current loads, or at least comparable.

The first semiconductor switching elements or MOSFETs are preferably dimensioned in such a way that they provide the highest power at currents below Iₜ and are also designed in particular to be favorable and sufficient for partial load operation, i.e. below a threshold value for the requested load (e.g. 30 to 40% of the full load).

FIG. 2b shows a diagram in which a torque M is plotted against an angular velocity ω of the electrical machine. The area 211 indicates a preferred operating range of the second partial power converter, i.e. the two-level power converter, and is intended for lower power or load, but better efficiency. The range 212, on the other hand, indicates a preferred operating range of the first partial power converter, i.e. the three-level power converter, which is intended for higher power or load, but possibly lower efficiency.

FIG. 1b schematically shows an electrical machine unit 100b, which comprises a power converter 110b and an electrical machine 130. In addition, an energy storage unit 150 designed as a battery and a computing unit 140 configured as an MCU are shown by way of example, whereby the computing unit 140 can be part of the electrical machine unit 100b and can be configured to operate it.

The electrical machine unit 100b basically corresponds to the electrical machine unit 100a shown in FIG. 1a; the only difference is in the power converter 110b.

The power converter 110b basically has the same elements as the power converter 110a according to FIG. 1a, in this respect reference is also made to the description there. The power converter 110b also has a first partial power converter 110.1b and a second partial power converter 110.2b, which are assigned the same elements as in the power converter 110a according to FIG. 1a.

Unlike the power converter 110a according to FIG. 1a, however, the first partial power converter 110.1b and the second partial power converter 110.2b are integrated into one another here. The three first half-bridges 112.1U, 112.1V, 112.1W and the three second half-bridges 112.2U, 112.2V, 112.2W are arranged somewhat differently here in terms of geometry, namely alternately a first and a second half-bridge. However, the electrical wiring corresponds to that of the power converter 110a shown in FIG. 1a. However, it is also conceivable that the first sub-converter 110.1b and the second sub-converter 110.2b are arranged very close to each other.

Furthermore, the power converter 110b, unlike the power converter 110a according to FIG. 1a, comprises a control unit 114 configured as a gate driver, via which the first and second semiconductor switching elements can be controlled, i.e. opened and closed or switched to non-conductive and conductive. This is possible, for example, because the two partial power converters are also integrated into one another and are therefore compact in design. In principle, however, two separate control units configured as gate drivers could also be provided here, as with the power converter 110a shown in FIG. 1a.

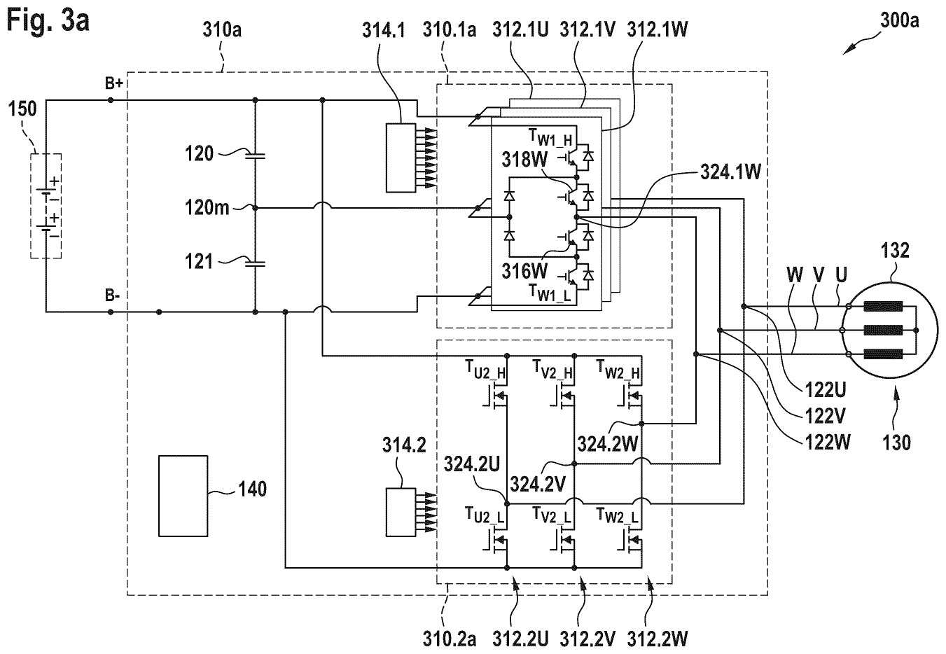

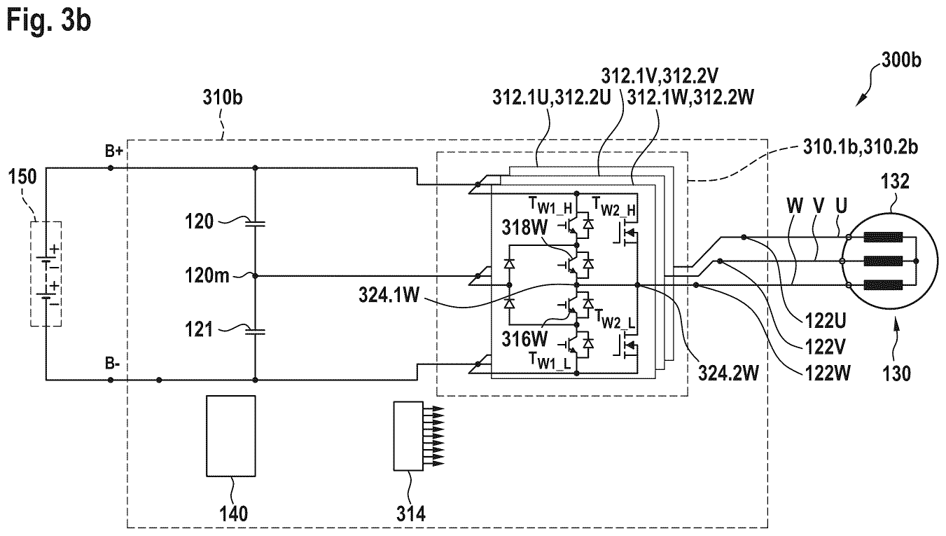

FIG. 3a schematically shows an electrical machine unit 300a, which comprises a power converter 110b and an electrical machine 130. In addition, an energy storage unit 150 designed as a battery and a computing unit 140 configured as an MCU are shown by way of example, whereby the computing unit 140 can be part of the electrical machine unit 300a and can be configured to operate it.

The electrical machine 130 is connected to the power converter or inverter 310a. The power converter 310a is in turn connected to the energy storage device 150 via two series-connected intermediate circuit capacitors 120, 121. Direct voltage provided by the battery 150 can be converted into alternating voltage for motor operation of the electric machine 130 via the power converter 310a. Conversely, AC voltage generated during generator operation of the electric machine 130 can also be converted into DC voltage via the (thus bidirectional) power converter 310a in order to charge the battery 150.

In particular, the power converter 310a may be a power converter according to the invention in a preferred embodiment. As already mentioned, the power converter can be provided not only for the operation of an electrical machine, but also for other electrical devices, for example if direct voltage is to be converted into alternating voltage or vice versa. In the following, however, the invention will be explained by way of example using it for the operation of an electrical machine, for example in a vehicle which, in addition to the electrical machine, also has the battery.

Three phases U, V and W are shown for the electrical machine 130, each of which comprises a phase winding 132 (designated only once). It should be noted that the terms phase and phase winding can also be used synonymously, whereby phase winding usually (only) refers to the winding or coil within the stator. The phase windings 132 are part of a stator of the electrical machine; a rotor of the electrical machine is not shown here.

The power converter 310a comprises two partial power converters, a first partial power converter 310.1a and a second partial power converter 310.2a. In addition, the power converter 310a comprises two DC voltage connections B+, B− and several, for example three, AC voltage connections 122U, 122V, 122W. The power converter 310a can be (electrically) connected or, as shown here, is connected to the energy storage device 150 via the DC voltage connections B+, B−. The DC link capacitors 120, 121 are also connected between the DC voltage connections. Via the AC voltage connections 122U, 122V, 122W, the power converter 310a can be connected to the phases of the electrical machine (electrically) or, as shown here, is connected.

The first partial power converter 310.1a comprises, by way of example, three first half-bridges 312.1U, 312.1V, 312.1W. The number of half-bridges corresponds in particular to the number of AC voltage connections, although only the first half-bridge 312.1W is shown in detail; however, the other first half-bridges are constructed accordingly.

The first half-bridge 312.1W has four first semiconductor switching elements, a high-side switching element T_{W1_H}, a further high-side switching element 318W, a low-side switching element T_{W1_L}, and a further low-side switching element 316W. In addition, first half-bridge 312.1W has a center tap 324.1W, which is arranged between the two high-side switching elements and the two low-side switching elements, and via which the respective half-bridge is electrically connected or can be connected to the respective phase connection.

The DC voltage sides of the first half bridges are each (electrically) connected to each other and to one of the two DC voltage connections. The DC voltage side located on the side of the high-side switching elements is connected to the positive DC voltage connection B+, and the DC voltage side located on the side of the low-side switching elements is connected to the negative DC voltage connection B−.

The two high-side switching elements or the two low-side switching elements can each be controlled together in order to connect the basic function of the half-bridge, i.e. the connection of the center tap to either the positive DC voltage connection B+or the negative DC voltage connection B−. Intermediate steps are also conceivable.

In addition, however, the first semiconductor switching elements 316W, 318W can be used to connect the center tap 324.1W to the center tap 120m between the two intermediate circuit capacitors 120, 121. For this purpose, electrical connections are provided on the one hand between the two first switching elements T_{W1_H}, and 318W and on the other hand between the two first switching elements T_{W1_L}, and 316W. In addition, two diodes are connected in parallel to the two first semiconductor switching elements 316W, 318W. The same applies to the other first half-bridges, with the center tap 120m being connected or connectable together with all first half-bridges.

These additional first semiconductor switching elements 316W, 318W can be used to generate a further average voltage level in addition to the voltage levels of the DC voltage connections. This makes it a three-level power converter, namely of the NPC type.

Furthermore, the first partial power converter 310.1a comprises a control unit 314.1 configured as a gate driver, via which the first semiconductor switching elements can be controlled, i.e. opened and closed or be switched to non-conductive and conductive.

The second partial power converter 310.2 comprises, by way of example, three second half-bridges 312.2U, 312.2V, 312.2W. The number of half-bridges corresponds in particular to the number of AC voltage connections. Each of the three second half-bridges in turn has two second semiconductor switching elements, a high-side switching element T_{U2_H}, T_{V2_H} or T_{W2_H}, and a low-side switching element T_{U2_L}, T_{V2_L} or T_{W2_L}. Each of the second half-bridges has a center tap 124.2U, 124.2V, 124.2W, which is arranged between the two second semiconductor switching elements and via which the respective half-bridge is electrically connected or can be connected to the respective phase connection.

The DC voltage sides of the second half bridges are each (electrically) connected to each other and to one of the two DC voltage connections. The DC voltage side located on the side of the high-side switching elements is connected to the positive DC voltage connection B+, and the DC voltage side located on the side of the low-side switching elements is connected to the negative DC voltage connection B−.

The second partial power converter is therefore a two-level power converter.

Furthermore, the second partial power converter 310.2a comprises a control unit 314.2 configured as a gate driver, via which the second semiconductor switching elements can be controlled, i.e. opened and closed or be switched to non-conductive and conductive.

The first partial power converter 310.1a and the second partial power converter 310.2a are thus each constructed in themselves like a conventional three-level power converter or two-level power converter, whereby both are connected in parallel with one another and each between the two DC voltage connections B+, B− and the multiple AC voltage connections 122U, 122V, 122W. In addition, the first partial power converter 310.1a and the second partial power converter 310.2a are designed separately from one another.

The MCU 140 can, for example, be configured to control the first partial power converter 310.1a and the second partial power converter 310.2a via their respective gate drivers 314.1, 314.2, e.g. via suitable PWM signals.

There is a further difference between the first partial power converter 310.1a and the second partial power converter 310.2a. The first semiconductor switching elements T_{W1_H}, T_{W1_L}, 316W, 318W and those of the other first half-bridges are different from the second semiconductor switching elements T_{U2_H}, T_{V2_H}, T_{W2_H}, T_{U2_L}, T_{V2_L}, T_{W2_L}, in particular with regard to their kind or type.

Preferably, the first semiconductor switching elements are designed as IGBTs (IGBT stands for “insulated-gate bipolar transistor”), while the second semiconductor switching elements are designed as MOSFETs (MOSFET stands for “metal-oxide-semiconductor field-effect transistor”), in particular as SiC MOSFETs. SiC stands for silicon carbide, and such SiC MOSFETs are MOSFETs with a wide bandgap.

In this way, the first partial power converter 310.1a and the second partial power converter 310.2a are differently suited for different conditions; depending on the situation, only one of the partial power converters or both can be used together. Irrespective of this, the use of the two partial power converters connected in parallel allows inherent fault safety.

It should be mentioned that the aspects and advantages explained for the power converter 110a also apply.

FIG. 3b schematically shows an electrical machine unit 300b, which has a power converter 310b and an electrical machine 130. In addition, an energy storage unit 150 designed as a battery and a computing unit 140 configured as an MCU are shown by way of example, whereby the computing unit 140 can be part of the electrical machine unit 300b and can be set up to operate it.

The electrical machine unit 300b basically corresponds to the electrical machine unit 300a shown in FIG. 3a, the only difference being the power converter 310b.

The power converter 310b basically has the same elements as the power converter 310a according to FIG. 3a, in this respect reference is also made to the description there. The power converter 310b also comprises a first partial power converter 310.1b and a second partial power converter 310.2b, which are assigned the same elements as in the power converter 310a according to FIG. 3a.

Unlike the power converter 310a according to FIG. 3a, however, the first partial power converter 310.1b and the second partial power converter 310.2b are integrated into one another here. The three first half bridges 312.1U, 312.1V, 312.1W and the three second half bridges 312.2U, 312.2V, 312.2W are geometrically arranged slightly differently here, namely the first and second half bridges for each phase are arranged together. However, the electrical wiring corresponds to that of the power converter 310a shown in FIG. 3a. However, it is also conceivable that the first partial power converter 310.1b and the second partial power converter 310.2b are arranged very close to each other.

Furthermore, the power converter 310b, unlike the power converter 310a according to FIG. 3a, comprises a control unit 314 configured as a gate driver, via which the first and second semiconductor switching elements can be controlled, i.e. opened and closed or be switched to non-conductive and conductive. This is possible, for example, because the two partial power converters are also integrated into one another and are therefore compact in design. In principle, however, two separate control units designed as gate drivers could also be provided here, as with the power converter 310a shown in FIG. 3a.

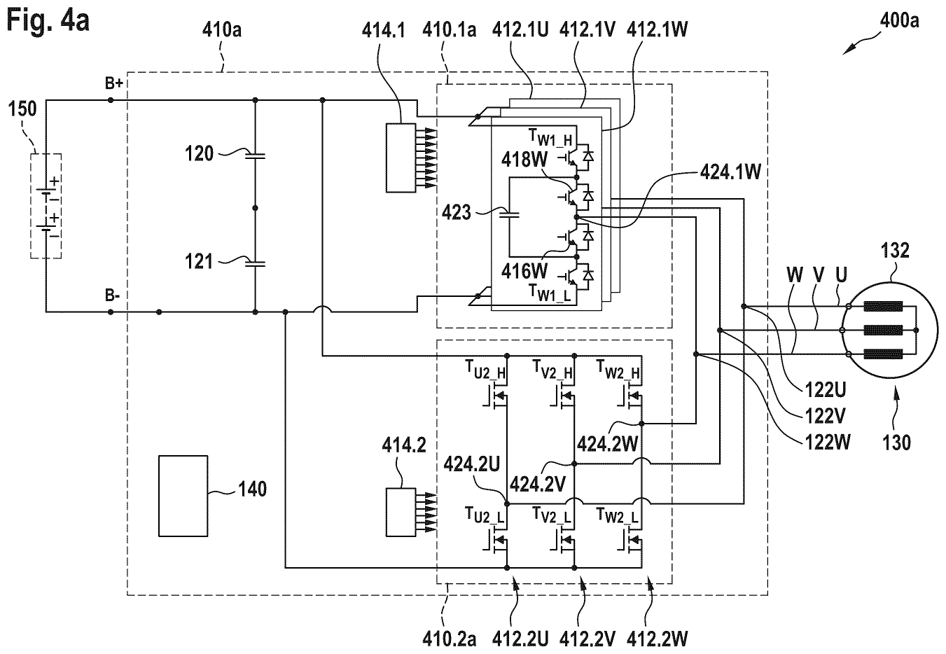

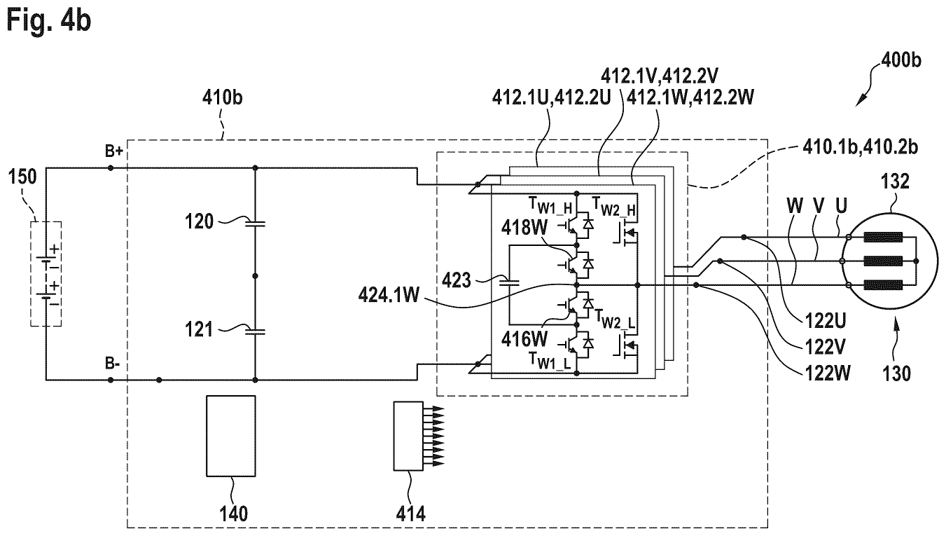

FIG. 4a schematically shows an electrical machine unit 400a, which comprises a power converter 410a and an electrical machine 130. In addition, an energy storage unit 150 designed as a battery and a computing unit 140 configured as an MCU are shown by way of example, whereby the computing unit 140 can be part of the electrical machine unit 400a and can be configured to operate it.

The electrical machine 130 is connected to the power converter or inverter 410a. The power converter 410a is in turn connected to the energy storage device 150 via two series-connected DC link capacitors 120, 121. Direct voltage provided by the battery 150 can be converted into alternating voltage for motor operation of the electric machine 130 via the power converter 410a. Conversely, AC voltage generated during generator operation of the electric machine 130 can also be converted into DC voltage via the (thus bidirectional) power converter 410a in order to charge the battery 150.

In particular, the power converter 410a may be a power converter according to the invention in a preferred embodiment. As already mentioned, the power converter can be provided not only for the operation of an electrical machine, but also for other electrical devices, for example if direct voltage is to be converted into alternating voltage or vice versa. In the following, however, the invention will be explained by way of example with reference to its use for operating an electrical machine, for example in a vehicle which, in addition to the electrical machine, also comprises the battery.

Three phases U, V and W are shown for the electrical machine 130, each comprising a phase winding 132 (designated only once). It should be noted that the terms phase and phase winding can also be used synonymously, whereby phase winding usually (only) refers to the winding or coil within the stator. The phase windings 132 are part of a stator of the electrical machine; a rotor of the electrical machine is not shown here.

The power converter 410a comprises two partial power converters, a first partial power converter 410.1a and a second partial power converter 410.2a. In addition, the power converter 410a has two DC voltage connections B+, B− and several, for example three, AC voltage connections 122U, 122V, 122W. The power converter 410a can be (electrically) connected or, as shown here, is connected to the energy storage device 150 via the DC voltage connections B+, B−. The DC link capacitors 120, 121 are also connected between the DC voltage connections. Via the AC voltage connections 122U, 122V, 122W, the power converter 410a can be connected to the phases of the electrical machine (electrically) or, as shown here, is connected.

The first partial power converter 410.1a has, by way of example, three first half-bridges 412.1U, 412.1V, 412.1W. The number of half-bridges corresponds in particular to the number of AC voltage connections, although only the first half-bridge 412.1W is shown in detail; however, the other first half-bridges are constructed accordingly.

The first half-bridge 412.1W has four first semiconductor switching elements, a high-side switching element T_{W1_H}, a further high-side switching element 418W, a low-side switching element T_{W1_L}, and a further low-side switching element 416W. In addition, the first half-bridge 412.1W has a center tap 424.1W, which is arranged between the two high-side switching elements and the two low-side switching elements, and via which the respective half-bridge is electrically connected or can be connected to the respective phase connection.

The DC voltage sides of the first half bridges are each (electrically) connected to each other and to one of the two DC voltage connections. The DC voltage side located on the side of the high-side switching elements is connected to the positive DC voltage connection B+, and the DC voltage side located on the side of the low-side switching elements is connected to the negative DC voltage connection B−.

The two high-side switching elements or the two low-side switching elements can each be controlled together for the basic function of the half bridge, i.e. the connection of the center tap to either the positive DC voltage connection B+or the negative DC voltage connection B−. Intermediate steps are also conceivable.

In addition, however, the first semiconductor switching elements 416W, 418W can be used to connect the center tap 424.1W to a capacitor 423. For this purpose, electrical connections are provided on the one hand between the two first switching elements T_{W1_H}, and 318W and on the other hand between the two first switching elements T_{W1_L}, and 316W. The same applies to the other first half-bridges, where a corresponding capacitor is also provided in each case (i.e. for each phase).

These additional first semiconductor switching elements 416W, 418W can be used to generate a further average voltage level in addition to the voltage levels of the DC voltage connections. This results in a three-level power converter of the flying capacitor type.

Furthermore, the first partial power converter 410.1a comprises a control unit 414.1 configured as a gate driver, via which the first semiconductor switching elements can be controlled, i.e. opened and closed or be switched to non-conductive and conductive.

The second partial power converter 410.2 has three exemplary second half bridges 412.2U, 412.2V, 412.2W. The number of half bridges corresponds in particular to the number of AC voltage connections. Each of the three second half-bridges in turn has two second semiconductor switching elements, a high-side switching element T_{U2_H}, T_{V2_H} or T_{W2_H}, and a low-side switching element T_{U2_L}, T_{V2_L} or T_{W2_L}. Each of the second half-bridges has a center tap 424.2U, 424.2V, 424.2W, which is arranged between the two second semiconductor switching elements and via which the respective half-bridge is electrically connected or can be connected to the respective phase connection.

The DC voltage sides of the second half bridges are each (electrically) connected to each other and to one of the two DC voltage connections. The DC voltage side located on the side of the high-side switching elements is connected to the positive DC voltage connection B+, and the DC voltage side located on the side of the low-side switching elements is connected to the negative DC voltage connection B−.

The second partial converter is therefore a two-level converter.

Furthermore, the second partial power converter 410.2a comprises a control unit 414.2 configured as a gate driver, via which the second semiconductor switching elements can be controlled, i.e. opened and closed or be switched to non-conductive and conductive

The first partial power converter 410.1a and the second partial power converter 410.2a are thus each constructed in themselves like a conventional three-level power converter or two-level power converter, whereby both are connected in parallel to one another and each between the two DC voltage connections B+, B− and the multiple AC voltage connections 122U, 122V, 122W. In addition, the first partial power converter 410.1a and the second partial power converter 410.2a are designed separately from one another.

The MCU 140 can, for example, be configured to control the first partial power converter 410.1a and the second partial power converter 410.2a via their respective gate drivers 414.1, 414.2, e.g. via suitable PWM signals.

There is a further difference between the first partial power converter 410.1a and the second partial power converter 410.2a. The first semiconductor switching elements T_{W1_H}, T_{W1_L}, 416W, 418W and those of the other first half-bridges are different from the second semiconductor switching elements T_{U2_H}, T_{V2_H}, T_{W2_H}, T_{U2_L}, T_{V2_L}, T_{W2_L}, in particular with regard to their kind or type.

Preferably, the first semiconductor switching elements are designed as IGBTs (IGBT stands for “insulated-gate bipolar transistor”), while the second semiconductor switching elements are designed as MOSFETs (MOSFET stands for “metal-oxide-semiconductor field-effect transistor”), in particular as SiC MOSFETs. SiC stands for silicon carbide, and such SiC MOSFETs are MOSFETs with a wide bandgap.

In this way, the first partial power converter 410.1a and the second partial power converter 410.2a are differently suited for different conditions; depending on the situation, only one of the partial power converters or both can be used together.

Irrespective of this, the use of the two partial power converters connected in parallel allows inherent fault safety.

It should be mentioned that the aspects and advantages explained for the power converter 110a also apply.

FIG. 4b schematically shows an electrical machine unit 400b, which comprises a power converter 410b and an electrical machine 130. In addition, an energy storage unit 150 designed as a battery and a computing unit 140 configured as an MCU are shown by way of example, whereby the computing unit 140 can be part of the electrical machine unit 400b and can be configured up to operate it.

The electrical machine unit 400b basically corresponds to the electrical machine unit 400a shown in FIG. 4a, the only difference being the power converter 410b.

The power converter 410b basically has the same elements as the power converter 410a according to FIG. 4a, in this respect reference is also made to the description there. The power converter 410b also comprises a first partial power converter 410.1b and a second partial power converter 410.2b, which are assigned the same elements as in the power converter 410a according to FIG. 4a.

Unlike the power converter 410a according to FIG. 4a, however, the first partial power converter 410.1b and the second partial power converter 410.2b are integrated into one another here. The three first half bridges 412.1U, 412.1V, 412.1W and the three second half bridges 412.2U, 412.2V, 412.2W are geometrically arranged slightly differently here, namely the first and second half bridges for each phase are arranged together. However, the electrical wiring corresponds to that of the power converter 410a shown in FIG. 4a. However, it is also conceivable that the first partial power converter 410.1b and the second partial power converter 410.2b are arranged very close to each other.

Furthermore, the power converter 410b, unlike the power converter 410a according to FIG. 4a, comprises a control unit 414 configured as a gate driver, via which the first and second semiconductor switching elements can be controlled, i.e. opened and closed or be switched to non-conductive and conductive. This is possible, for example, because the two partial power converters are also integrated into one another and are therefore compact in design. In principle, however, two separate control units configured as gate drivers could also be provided here, as with the power converter 410a shown in FIG. 4a.

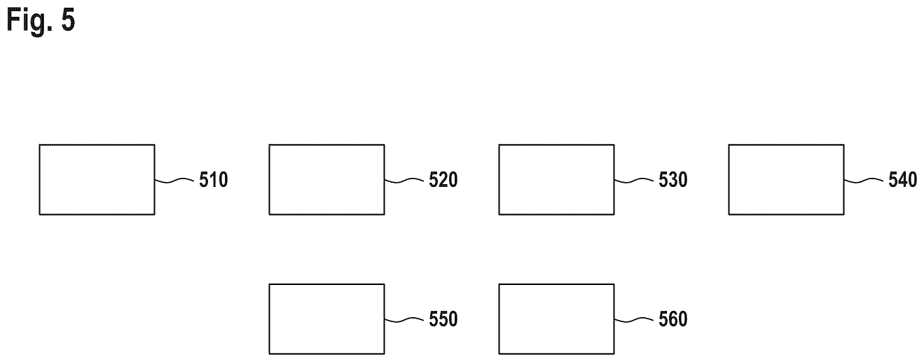

FIG. 5 shows a rough schematic of methods according to the invention in preferred embodiments. These are methods for converting current using a power converter, as shown, for example, in one of FIGS. 1a, 1b, 3a, 3b, 4a, 4b. This can also refer to the operation of a power converter.

In a partial operating mode, only one of the first and second partial power converters is used for current conversion, while the other of the first and second partial power converters is inactive. Thus, in a first partial operating mode 510, e.g. with partial or light loads up to medium loads, only the second partial power converter can be used to convert the current, while the first partial power converter is inactive. The MCU therefore only controls the electrical machine with the second partial power converter with the SiC MOSFETs, for example.

In a second partial operating mode 520, on the other hand, e.g. with a high load or high torque, but at least with a higher load and/or higher torque than in the first partial operating mode 510, the first partial power converter is used to convert the current, for example, and is operated, e.g. in PWM switching, while the second partial power converter is inactive. The MCU thus controls the electrical machine, for example, only with the first partial power converter with the IGBTs. For example, a threshold value can be specified for a requested load, which is used to decide whether the first or second partial operating mode is used.

As can be seen from the diagram in FIG. 2a, the characteristic curves of the relevant semiconductor switching elements result in particularly efficient operation depending on the load or torque.

In a mixed operating mode, on the other hand, the first and second partial power converters can be active and used together. Here, for example, in a first mixed operating mode 530 (which can also be referred to as boost mode), the first partial power converter (the three-level power converter, in particular with IGBTs) can be switched on or activated first. Then the second partial converter (the two-level converter, especially with MOSFETs) is switched on or activated; this allows the current to be increased (as the rated power of the second partial converter is usually lower). The voltage of the gate and the impedance of the line should be set so that the current is correctly divided between the two partial power converters and overloading is avoided.

If the rated power of the two partial power converters is almost equal (i.e. within certain tolerances), then a second mixed operating mode 540 can be used. Here, the bridge with the lower switching losses can be switched on or activated first and then the other bridge can be switched on or activated; typically, the switching losses in the second partial power converter will be lower than in the first partial power converter, the three-level power converter with IGBTs, for example. The current sharing between the bridges (or partial power converters) considerably reduces the conduction loss without significantly increasing the switching losses. When switching off, the bridge or partial power converter with the higher switching losses can be switched off and then the bridge or partial power converter with the lower switching losses is switched on.

Furthermore, for example, a charging or energy transfer mode 550, in particular an integrated charging mode, can be provided. Here, it is then preferable if the charging of a battery (or generally an energy transfer between an energy storage device and a power grid) is carried out via the second partial power converter (i.e. in particular with the MOSFETs); here, the combination of the machine winding with the second partial power converter can then form an AC rectifier or, in the case of a charging adaptation, they can work like a DC-DC converter, e.g. to convert a 400 V to 800 V DC charging system). In this case, the second partial power converter is suitable due to its better energy efficiency.

An active short-circuit mode 560 can also be provided, for example. In this mode, all low-side or high-side switches can be closed. For this purpose, first the low-side switches of the first partial power converter (with e.g. IGBTs) are closed (all switches between the center tap and the negative DC voltage connection, B−, these are typically two series switches for Fly Cap and NPC and for the T-type only one switch) and then the low-side switches of the second partial power converter (with the MOSFETs). To open, first the second and then the first partial converter can be switched off. The same procedure can be used for the high-side switches in the event of an active short circuit. This mode is useful when the machine current is very high during the first few cycles of the active short circuit and the switches do not need to be oversized based on this current. Again, special care should be taken when splitting the current between IGBT and SiC switches.

1. A power converter (110a, 110b, 310a, 310b, 410a, 410b) with two DC voltage connections (B+, B−) and several AC voltage connections (122U, 122V, 122W),
wherein the power converter comprises a first partial power converter (110.1a, 110.1b, 310.1a, 310.1b, 410.1a, 410.1b) and a second partial power converter (110.2a, 110.2b, 310.2a, 310.2b, 410.2a, 410.2b),
wherein the first partial power converter comprises first semiconductor switching elements (T_{U1_H}, T_{V1_H}, T_{W1_H}, T_{U1_L}, T_{V1_L}, T_{W1_L}, 116U, 116V, 116W, 118U, 118W, 316W, 318W, 416W, 418W) and is configured as a three-level power converter or power converter with more than three levels,
wherein the second partial power converter comprises second semiconductor switching elements (T_{U2_H}, T_{V2_H}, T_{W_ H}, T_{U2_L}, T_{V2_L}, T_{W2_L}) and is configured as a two-level power converter, and
wherein the first partial power converter and the second partial power converter are each connected or are connectable between the two DC voltage connections (B+, B−) and the several AC voltage connections (122U, 122V, 122W).

2. The power converter (110a, 110b, 310a, 310b, 410a, 410_{b}) according to claim 1, wherein the first semiconductor switching elements and the second semiconductor switching elements are different from each other, in particular are of different types.

3. The power converter (110a, 110b, 310a, 310b, 410a, 410_{b}) according to claim 2, wherein the first semiconductor switching elements (T_{U1_H}, T_{V1_}H, T_{W1_H}, T_{U1_L}, T_{V1_L}, T_{W1_L}) comprise or are IGBTs.

4. The power converter (110a, 110b, 310a, 310b, 410a, 410_{b}) according to claim 2, wherein the second semiconductor switching elements (T_{U2_H}, T_{V2_}H, T_{W2_H}, T_{U2_L}, T_{V2_L}, T_{W2_L}) comprise or are MOSFETs, in particular SiC-MOSFETs and/or GaN-HEMTs.

5. The power converter (110a, 110b, 310a, 310b, 410a, 410_{b}) according to claim 1, wherein the first partial power converter is configured as a three-level power converter of the T-type, NPC-type or flying capacitor type.

6. The power converter (110a, 110b, 310a, 310b, 410a, 410_{b}) according to claim 1, wherein the second partial power converter comprises a plurality of second half bridges (112.2U, 112.2V, 112.2W) each having two of the second semiconductor switching elements (T_{U2_H}, T_{V2_H}, T_{W2_H}, T_{U2_}L, T_{V2_L}, T_{W2_L}).

7. The power converter (110a, 310a, 410a) according to claim 1 wherein the first partial power converter (110.1a, 310.1a) and the second partial power converter (110.2a, 310.2a) are connected in parallel to one another and are formed separately from one another.

8. The power converter (110b, 310b, 410b) according to claim 1 wherein the first partial power converter and the second partial power converter are integrated into each other.

9. An electrical machine unit (100a, 100b, 300a, 300b, 400a, 400b) comprising an electrical machine (130) having one or more phases and a power converter (110a, 110b, 310a, 310b, 410a, 410b) according to claim 1, wherein the one or more phases are each connected to a respective one of the several AC voltage connections.

10. The electrical machine unit (100a, 100b, 300a, 300b, 400a, 400b) according to claim 9, which is configured as a traction drive of a vehicle.

11. A method of power conversion using a power converter (110a, 110b, 310a, 310b, 410a, 410b) according to claim 1.

12. The method according to claim 11, wherein, in a partial operation mode (510, 520), only one of the first and second partial power converters is used for current conversion, and wherein the other of the first and second partial power converters is inactive.

13. The method according to claim 12, wherein, in a first partial operation mode (510), when a demanded load is below a predetermined threshold, the second partial power converter is used for current conversion, and/or wherein, in a second partial operation mode (520), when a demanded load is above the predetermined threshold, the first partial power converter is used for current conversion.

14. The method according to claim 11, wherein, in a mixed mode operation (530, 540), the first and second partial power converters are used for current conversion.

15. The method according to claim 14, wherein, in a first mixed mode operation mode (530), the first partial power converter is activated first, and then the second partial power converter is activated.

16. The method according to claim 14, wherein, in a second mixed mode operation (540), and when the first and second partial power converters have an equal rated power within predetermined tolerances, the one of the first and second partial power converters that has lower switching losses is activated first, and then the other of the first and second partial power converters is activated.

17. The method according to claim 11, wherein, in an energy transfer mode (550) in which energy is transferred between an energy storage and a power grid via the power converter, the second partial power converter is used for power conversion.

18. The method according to claim 11, wherein, in an active-short-circuit mode (560), all low-side or high-side semiconductor switching elements are closed, wherein first the low-side or high-side semiconductor switching elements of the first partial power converter are closed and then the low-side or high-side switching elements of the second partial power converter are closed.

19. A method of power conversion using an electrical machine unit (100a, 100b, 300a, 300b, 400a, 400b) according to claim 9.
